(19) United States
(12) Patent Application Publication
(10) Pub. No.: US 2004/0026093 A1
(43) Pub. Date: Feb. 12, 2004

(54) Horseshoe arrangement

(76) Inventor: Lars Nilsson, Vasteras (SE)

Correspondence Address: NIXON & VANDERHYE, PC, 1100 N GLEBE ROAD, 8TH FLOOR, ARLINGTON, VA, 22201-4714, US

(21) Appl. No.: 10/240,194

(22) PCT Filed: Mar. 29, 2001
(86) PCT No.: PCT/SE01/00693

(30) Foreign Application Priority Data
Mar. 30, 2002 (SE) 0001131-2

(51) Int. Cl. A01L 1/04

(52) U.S. Cl. 168/6; 168/12; 168/23

(57) ABSTRACT

The invention relates to a horseshoe arrangement (2) of the kind that comprises a first part (21), which lies proximal to a horse's hoof, and a second part (22) which lies proximal to the ground, wherewith said first part (21) has a horseshoe shape and consists of hard material, such as metal material, and said second part (22) has a corresponding horseshoe shape and consists of a resilient material, such as a plastic material. The two parts (21, 22) are mutually co-ordinated so that each nail-accommodating hole (21a, 22a) will extend through said two parts (21, 22). Each hole (21a) of the first part (21) has a cross-sectional size that exceeds the cross-sectional size of the hoof-penetrating portion (3a) of a nail (3). Each hole (21a) of the horseshoe-shaped part (21) has at its hoof-distal periphery a plurality of hole-encircling surface sections (21b, 21c) which are coordinated pair-wise and adapted for sliding co-action with nail-associated support surfaces (3b, 3c) proximal to horse's hoof.

### FIELD OF INVENTION

The present invention relates generally to a horseshoe arrangement and then more particularly to a horseshoe arrangement that consists of two parts, a hoof-proximal first part and a ground-proximal second part.

The first part has a shape typical of a horseshoe, such as a U-shape and consists of a hard material, such as a metal material.

The second part has a corresponding horseshoe shape, which is exemplified hereinafter simply as a U-shape, consisting of a resilient material, such as a plastic material, for instance a polyurethane plastic.

The invention is based on the concept of allowing the two parts to be coordinated one with the other so that each hole intended for a horseshoe nail will extend straight through said two parts.

More specifically, the invention is based on the concept of allowing each hole belonging to said first part to have a cross-section that is larger than the cross-section of a hoof-penetrating nail-portion.

### DESCRIPTION OF THE BACKGROUND ART

Several different types of horseshoe arrangements that consist of a first part and a second part are known to the art.

For instance, Swedish Patent publication SE-C2-511 451 teaches a horseshoe that includes a metal core (1) which is generally enclosed in an essentially elastically deformable material, such as a rubber or a rubber-like material.

According to this publication, the thickness of the elastically deformable material is much greater on the underside of the core (1) than at the top of the core.

Each nail-accommodating hole is arranged to extend through the two parts of the horseshoe.

The width of the ground-proximal surface on the underside of the horse-shoe is narrower than the upper hoof-abutting surface throughout the full U-shaped extension of the horseshoe.

Swedish Patent Specification 21 587 and SE-C2-508 583 teach further examples of prior art horseshoe arrangements that consist of a first and a second part.

When considering the features and properties of the horseshoe arrangement according to the present invention it will be seen that a horseshoe through which nail-accommodating holes (6) extend and which comprises an elastic material (2) is known to the art from Swedish Patent Publication SE-C2-503 946.

A number of metal washers or plates (3) corresponding to the number of holes and nails are moulded in said elastic material, each of said metal plates having a limited extension.

When the horseshoe is nailed firmly to the hoof of a horse, the nails (4) extend through holes in the plates (3) and holes (6) in the U-shaped part of the horseshoe or a metal plate. It will be noted in this respect that a conical head portion of the horseshoe nail is fixed in relation to the washer and that this head portion extends through the metal plate (1).

The U-shaped hoof-abutting part of the horseshoe consists of a metal plate (1) with said elastic or resilient material (2) affixed to the underside of said plate.

The washers (3) are intended for abutment with the metal plate (1) and are movable horizontally through the effect exerted by the elastic material and relative to said material.

It is mentioned in particular that the hole (6) in the metal plate (1) has a much greater cross-sectional area than that of the hoof-penetrating part (4) of the nail, and that the nail together with the washer (3) is able to move horizontally in relation to the metal plate (1) when the hoof is subjected to load and to spring back to its original position when the load ceases.

FIGS. 1A and 1B of said patent publication show that the hole (6) in the metal plate (1) is much larger than the adjacent part of the nail, and that the washer or plate (3) has an extension which covers the hole in an illustrated intermediate position but that will lie in line with or pass beyond the delimiting surface of the hole (6) at each end position.

This prior patent publication teaches a horseshoe attachment which is so constructed and of such a nature that each time a horse moves and subjects its hoof to load, the hoof will be subjected to a pressure that results in a tendency for the hoof to expand slightly.

When a horse has been shod with the horseshoe attached conventionally with the aid of horseshoe nails inserted in nail-adapted holes, the horseshoe and its attachment will counteract this expansion.

According to this prior patent publication this is considered an unnatural state for the horse and that it can cause pain and therewith hamper the horse's movements.

Similar to the present invention, the prior patent publication relates to a horseshoe attachment that will enable the hoof to expand in a natural fashion.

It will also be noted that this construction comprises a first part which will include said metal plate (1) and each of said washers (3).

Other relevant patent publications in respect of the present invention are EP-A1-0 446 562, EP-A1-0 823 560 and U.S. Pat. No. 1,953,281.

### SUMMARY OF THE INVENTION

Technical Problems

When taking into consideration the technical deliberations that a person skilled in this particular art must make in order to provide a solution to one or more technical problems that he/she encounters, it will be seen that on the one hand it is necessary initially to realise the measures and/or the sequence of measures that must be undertaken to this end, and on the other hand to realise which means is/are required in solving one or more of said problems. On this basis, it will evident that the technical problems listed below are highly relevant to the development of the present invention.

When considering the present state of the art and a horseshoe arrangement of the kind defined in the introduction it will be seen that a technical problem resides in the provision of conditions, with the aid of simple means, which enable each of the washers (3) stated in the prior patent publication SE-C2-503 948 to be eliminated while, nevertheless, providing conditions that will permit said desired expansion and said flexible attachment to be attained.

In this respect, a technical problem also resides in realising the significance of and the advantages associated with allowing each hole in the first part of the horseshoe to present or form at its hoof-distal periphery a plurality of surface sections that encircle said hole either completely or partially.

Another technical problem is one of realising the significance of and the advantages afforded by allowing said hole-encircling surface sections to be pair-wise coordinated diametrically with respect to said hole and adapted for sliding co-action with nail-associated support surfaces that face towards the horse's hoof.

Another technical problem is one of realising the significance of and the advantages associated with allowing said co-ordination between the first and the second part of the horseshoe to consist in fastening said second part to said first part through the medium of a moulding or casting process, so that the two parts of each horseshoe arrangement will constitute an integrated part.

Another technical problem is one of realising the significance and the advantages associated with allowing holes belonging to each first part to have a square or at least a generally square cross-sectional shape with surface sections that face or extend away from the hole or diametrically opposed therein forming two of said hole-encircling surface sections.

Another technical problem is one of realising the significance of and the advantages associated with allowing each hole associated with said first part to have further surface sections that face or extend away from the hole and that form a further two of said hole-surrounding surface sections.

Another technical problem is one of providing conditions such that two surface sections that face away from said hole will allow relative movement between a hoof-penetrating portion of a horseshoe nail and said hole in the region of a first chosen value.

Another technical problem resides in realising the significance of and the advantages associated with allowing said two further surface sections that face away in said hole to allow relative movement between a portion of a hoof-penetrating nail and said hole in the region of a second chosen value which is slightly smaller than the first value.

Yet another technical problem is one of realising the significance of and the advantages associated with allowing said relative movement in respect of said first chosen value to be directed transversely to the longitudinal extension of said first part.

Still another technical problem resides in realising the significance of and the advantages associated with allowing nail-associated support surfaces proximal to the horse's hoof to have an extension which is adapted for co-action with said away-facing surface sections in respect of a horseshoe nail that has been inserted to the end of said hole.

Another technical problem is one of realising the significance of and the advantages associated with allocating to said hole a distance between opposing de-limiting surfaces that corresponds to, or at least essentially to, twice the thickness of the hoof-penetrating portion of the nail.

A further technical problem is one of realising the significance of and the advantages associated with allowing said surface sections to be orientated at right angles to the centre axis of the hole.

It will also be seen that a technical problem resides in realising the significance of and the advantages associated with allowing said surface sections to be orientated within a central part of said first part, and for said first part to have surface portions which diverge from said surface sections towards said second part.

Another technical problem resides in realising the significance of and the advantages afforded by allowing said second part to include a ground-proximal hole that has surfaces which converge towards the ground, and by allowing the head portion of the horseshoe nail sealingly to lie in tight abutment with said convergent surfaces.

Another technical problem is one of realising the significance of and the advantages associated with allowing said divergent surface portions and said convergent surfaces to be mutually coordinated so as to define therebetween a hole cavity in which the horseshoe nail can move freely, at least sideways.

Yet another technical problem is one of providing a novel nail construction and design that is well adapted for use with a horseshoe arrangement of the kind defined in the introduction and which can also be used in other horseshoe arrangements, where said nail shall typically include a head portion and a hoof penetrating portion.

Another technical problem is one of realising the significance of and the advantages associated with providing conditions in respect of said horseshoe nail that enable a widened portion to be formed between the head portion and the hoof penetrating portion of said nail.

Still another technical problem is one of realising the significance of and the advantages associated with providing said widened portion with slide surfaces that face towards said hoof penetrating portion.

A further technical problem resides in realising the significance of and the advantages afforded by allowing the slide surfaces on said widened portion to be orientated at right angles to the centre line or the longitudinal extension of said nail.

There is also a technical problem in realising the significance of and the advantages that are afforded by allowing said widened portion to have a length, which can be measured along the centre line, that corresponds to or is slightly shorter than a corresponding length of the head portion of the nail.

Solution

Taking its starting point from a horseshoe arrangement of the kind which consists of a hoof-proximal first part and a ground-proximal second part, wherein said first part has a horseshoe shape, such as a U-shape, and consists of a hard material, such as a metal material, and said second part has a corresponding horseshoe shape and consists of an elastically resilient material, such as a plastic material.

The two parts are mutually co-ordinated so that each nail-receiving hole will extend through said two parts, and where each hole belonging to said first part has a cross-sectional size that is greater than the cross-sectional size of the hoof-penetrating portion of the nail.

With the intention of solving one or more of the aforesaid technical problems, it is proposed in accordance with the invention that each hole in the horseshoe-shaped first part includes at its hoof-distal periphery a plurality of surface sections which encircle the hole and which are diametrically related to said hole, and which are coordinated pair wise and adapted for sliding co-action with nail-associated support surfaces that can be turned to face the horse's hoof.

By way of proposed embodiments that lie within the scope of the inventive concept it is also proposed in accordance with the invention that said co-ordination of said first and said second parts is achieved by fastening the second part to the first part, e.g. through the medium of a special casting or moulding process, so that said two parts of the horseshoe arrangement will thereby form an integrated unit.

It is also proposed in accordance with the present invention that each hole in the first part is given a square, or generally square, cross-sectional shape with surface sections that lie extend away from the hole and that are diametrically positioned therein, such as to form two of said hole-encircling surface sections.

It is also proposed that each hole in said first part has further surface sections which extend away from the hole and form a further two of said hole encircling surface sections.

There is also proposed in accordance with the invention a special dimensioning ruling that requires the two surface sections that extend away from the hole to permit relative movement between the hoof-penetrating portion of a nail and said hole up to a first chosen value, and two second surface sections that extend away from the hole and that function to permit relative movement between the hoof-penetrating portion of a nail and said hole up to a second chosen value, said second chosen value conveniently being smaller than the first chosen value.

It is also proposed in accordance with the invention that said relative movement is essentially directed horizontally and transversely to the longitudinal extension of the first part.

It is also proposed in accordance with the invention that the horseshoe nail includes horizontal support surfaces which can be turned towards the horse's hoof and which can be given a width adapted for co-action with surface sections that face away from the hole when the nail is displaced to the end of said hole.

It is also proposed in accordance with the invention that said hole is spaced at a distance between mutually opposing delimiting surfaces that coincide with or at least essentially with twice the thickness of the hoof-penetrating portion of the nail.

It is particularly proposed that said surface section is orientated at right angles (horizontally) to the centre axis of the hole.

According to one embodiment of the invention, said surface section is orientated within a centre section of said first horseshoe part, and that said first part has surface portions that diverge from said central section towards the second horseshoe part.

The second horseshoe part shall include a ground-proximal hole that has surfaces which converge from the first horseshoe part.

A head portion of the nail shall be adapted to tightly abut a central portion of said convergent surfaces.

The invention thus proposes that said divergent surface portions and said convergent surfaces are mutually coordinated to define a hole cavity in which the horseshoe nail can move freely, at least sideways.

There is also provided in accordance with the invention a horseshoe nail that typically includes a head portion and a pointed hoof-penetrating portion, wherein said nail includes particularly a widened part between said portions.

According to one embodiment the widened part includes slide surfaces that face towards said hoof-penetrating portion.

In addition, the widened portion shall include side surfaces that are orientated perpendicular to the centre line of the horseshoe nail.

The widened portion has a length which can be measured along a centre line and which corresponds to or is slightly shorter than the length of the head portion.

Advantages

Those advantages that are primarily characteristic of a horseshoe arrangement according to the present invention reside in the provision of conditions for fastening a two-part integrated horseshoe arrangement to a horse's hoof, so that the hoof is able to expand naturally, by providing the first part of each horseshoe with a hole that includes at its periphery distal from said hoof a plurality of hole-encircling surface sections which are orientated diametrically relative to said hole and which are co-ordinated pair-wise and adapted for sliding coaction with nail-associated support surfaces that can be turned to face the hoof.

There is also provided a horseshoe nail whose form is adapted to this end.

The primary characteristic features of an inventive horseshoe arrangement are set forth in the characterising clause of the accompanying claim 1.

The primary characteristic features of an inventive horseshoe nail are set forth in the characterising clause of the accompanying claim 15.

### BRIEF DESCRIPTION OF THE DRAWINGS

A horseshoe arrangement having features characteristically significant of the present invention will now be described with reference to the accompanying drawings, in which

FIG. 1 is a side view of a horse's hoof to which an inventive horseshoe arrangement has been applied;

FIG. 2 is a perspective, sectional view of an horseshoe arrangement according to FIG. 1, and shows an inserted horseshoe nail;

FIG. 3 is a corresponding perspective view of the inventive horseshoe arrangement, although with the ground-proximal elastic second part of said horseshoe omitted for reasons of clarity;

FIG. 4 is a plan view of the first part of said horseshoe arrangement, showing holes and inserted nails;

FIG. 5 is a side view of a first embodiment of an inventive horseshoe nail;

FIG. 6 is an enlarged horizontal view of the head portion of said nail;

FIG. 7 is a side view of the nail head shown in FIG. 6; and

FIG. 8 is a perspective view of a second embodiment of the head portion of an inventive horseshoe nail.

### DESCRIPTION OF EMBODIMENTS AT PRESENT PREFERRED

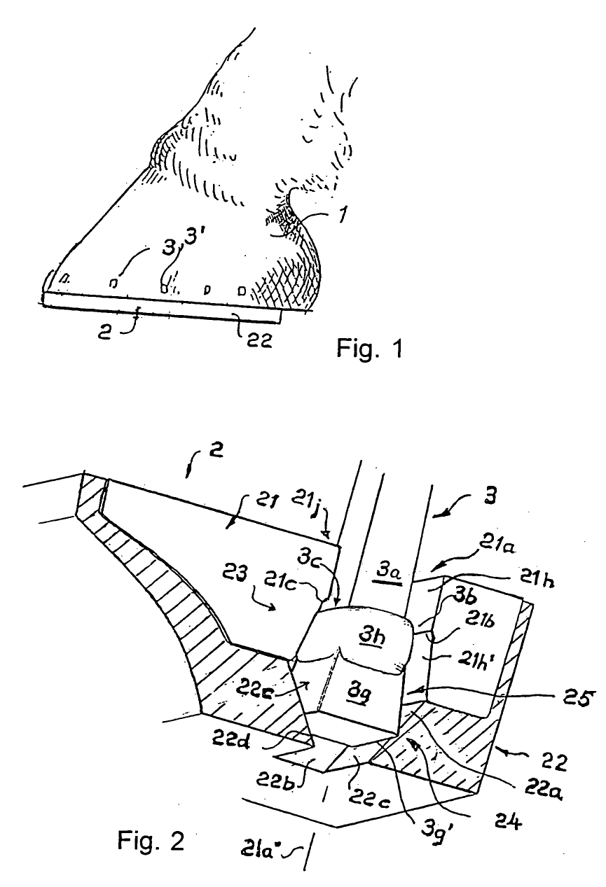

FIG. 1 is a side view of a horse's hoof 1 to which there is attached a horseshoe arrangement 2 of a kind commensurate with the present invention, wherein the horseshoe arrangement 2 is fastened to the hoof in a known manner, with the aid of a number of horseshoe nails, such as the nails 3, 3′.

FIG. 2 is a cross-sectional view of the horseshoe arrangement 2, which is of the kind that comprises a first part 21, which is intended to lie proximal to the horse's hoof, and a second part 22, which is intended to lie proximal to the ground.

The first part 21 has a horseshoe configuration, which is shown as a U-shape hereinafter, and consists of a hard material, such as a metal material.

The second part 22 has a corresponding horseshoe-shape or U-shape and is adapted to cover and enclose the first part 21. The second part 22 is comprised of an elastic or resilient material, such as a plastic material, preferably a polyurethane plastic.

The two parts 21, 22 are mutually coordinated, by virtue of the second part 22 being fastened to the first part 21 through the medium of a separate moulding or casting process.

In this respect, each nail-accommodating hole 21a, 22a is adapted to extend through said two parts 21, 22.

The hole in the first part 21 is referenced 21a, whereas the hole in the second part 22 is referenced 22a.

Each hole 21a in the first part has a cross-sectional area that exceeds the cross-sectional area of the part 3a of a nail 3 that penetrates the horse's hoof.

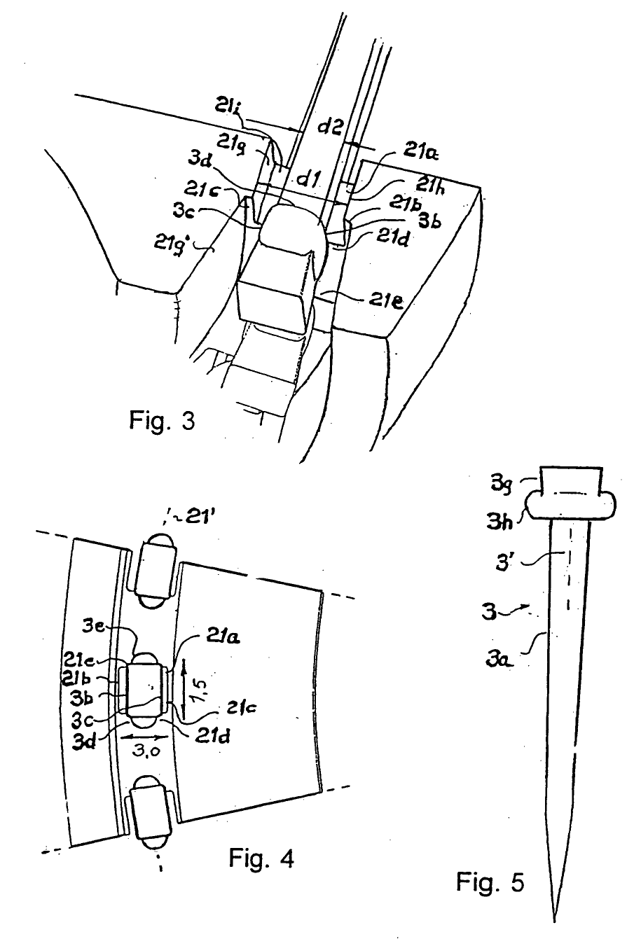

The hole 21a in the first part 21 has been given the measurement-related reference sign “d1”, in order to illustrate this cross-section, whereas the hoof-penetrating part 3a of the nail has been referenced “d2” in FIG. 3.

Each hole 21a in the horseshoe-shaped or U-shaped first part 21 has at its periphery distal from the horse's hoof a plurality of hole-encircling edge-formed surface sections 21b, 21c which are orientated diametrically with respect to the hole and coordinated pair-wise and adapted for sliding co-action with a nail-associated support surface 3b and 3c respectively that can be turned to face the horse's hoof.

The hole 21a of each first part 21 has an at least generally square cross-section with the edge-formed surface sections that face away from the hole forming said two hole-encircling surface sections 21b, 21c.

Each hole 21a of said first part 21 has further surface sections 21d, 21e that face away from the hole.

Two of the surface sections 21b, 21c that face away from the hole are adapted to permit relative movement between the hoof-penetrating nail portion 3a and said hole 21a up to a first selected value, which in the case of the FIG. 4 embodiment is given as 3.0 mm. This measurement can be considered applicable to a typical horseshoe and may therefore vary slightly in respect of other horseshoe sizes.

Two other surface sections 21d, 21e that face away from the hole are adapted to permit relative movement between the hoof-penetrating nail part 3a and said hole 21a up to a second chosen value, which is given as 1.5 mm in the FIG. 4 illustration. This measurement can be considered applicable to a typical horseshoe and may therefore vary slightly with horseshoes of other sizes.

This relative movement shall thus be directed primarily transversely to the longitudinal extension 21′ of the first part 21.

The nail-associated support surfaces 3b, 3c and 3d, 3e proximal to the horse's hoof have an extension which is adapted for co-action with surface sections that face away from the hole when a horseshoe nail is inserted to the end of the hole 21a.

The distance “d1” between mutually opposing delimiting surfaces of the hole 21, these surfaces being referenced 21g, 21h and 21i, 21j respectively, coincides at least essentially with the distance “d2” corresponding to double the thickness, of the hoof-penetrating nail part 3a.

These surface sections are orientated at right angles to the centre axis 21a′ of said hole.

The four surface sections 21b, 21c, 21d and 21e are orientated within a centre part 23 of said first horseshoe part 21, and said first part 21 includes U-shaped, curved surface parts 21g′, 21h′ which diverge towards the second horseshoe part 22.

According to FIG. 2, said second part 22 has facing towards the ground a hole 22a which includes four coordinated and mutually convergent surfaces 22b, 22c, 22d and 22e, this latter surface not being shown.

Each of the free edges of the connecting surface 3g′ of the nail head 3g is intended to lie sealingly against a respective one of said four convergent surfaces 22b, 22c, 22d and 22e and within the centre part 24 of said nail.

The divergent surface portions 21g′, 21h′ and said convergent surfaces 22b, 22c, 22d and 22e are coordinated mutually to form a hole cavity 25 within which the nail 3 is able to move freely, at least sideways.

The hole cavity 25 shall thus fully enclosed the nail head 3g and said widened portion 3h.

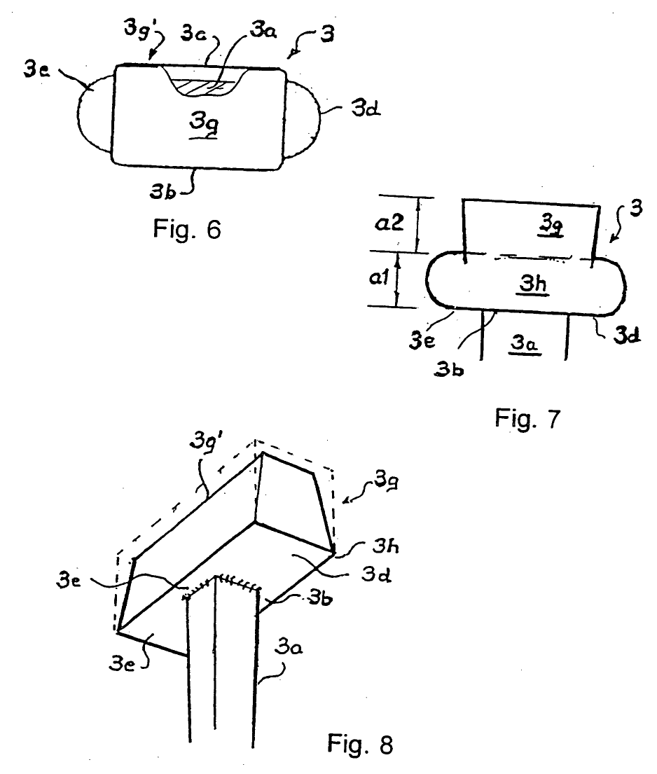

The invention also relates to a horseshoe nail 3 shown in FIGS. 5 to 7 and described hereinafter with reference to said Figures.

The illustrated nail 3 is adapted for use with a horseshoe arrangement 2 of the earlier described nature and typically includes a head portion 3g and a hoof-penetrating pointed portion 3a.

The illustrated nail includes a widened portion 3h between said two portions 3g and 3a.

The widened portion 3h includes four slide surfaces 3b, 3c, 3d and 3e which face towards said hoof-penetrating portion 3a.

The slide surfaces on the widened portion 3h are orientated at right angles to a nail centre line 3′.

In the case of the embodiment illustrated in FIGS. 5, 6 and 7, the widened portion 3h has a length “a1”, measurable along a centre line 3′, that corresponds to or is slightly shorter than a corresponding length “a2” of the head portion 3g.

It will be understood that the invention is not limited to the aforedescribed exemplifying embodiments thereof, and that modifications can be made within the scope of the inventive concept illustrated in the accompanying claims.

It will be particularly noted that the inventive concept can be applied in all types of horseshoe arrangements, such as the illustrated and described U-shaped horseshoe arrangement or horseshoe arrangements of other open kinds, such as cross shaped shoe or of a closed kind, such as ring shaped shoe, although other types of horseshoe may be included, such as pear shaped shoe.

FIG. 8 is a perspective view of another embodiment of the head portion 3g of a horseshoe nail.

This embodiment also includes four glide surfaces 3b, 3c, 3d and 3e that extend at right angles to the portion 3a.

The head portion 3g converges from the slide surfaces 3b, 3c, 3d and 3e (upwards in FIG. 8) to present an upper surface 3g′.

The form of a right-angled parallelepiped is illustrated in broken in FIG. 8. It will be evident from this that the head portion 3g has the form of a truncated pyramid with the base surface formed by the slide surfaces 3b, 3c, 3d and 3e.

Added Explanations at the Translation:

Cross shaped shoe=tvärtåsko: Horseshoe having a part of its front portion in the form of a crossing exposing forward oriented outer straight line.

Ring shaped shoe=ringsko: Horseshoe having an annular shape by a crossing attached to the outer portions of the shoebranches.

Pear shaped shoe=päronsko: Horseshoe having an annular shape by a crossing oriented to the intermediate portions of normal shoebranches and an extended portion backwards from said crossing and thus exposing a form essentially corresponding to the shape of a pear.

The following claim set replaces all prior versions, and listings, of claims in the application:

1. (Original) A horseshoe arrangement of the kind which comprises a first hoof-abutting part and a second ground-abutting part, wherewith said first part has a horseshoe configuration and consists of a hard material, such as a metal material, and said second part has a corresponding horseshoe configuration and consists of a resilient material, such as a plastic material, and wherewith said two parts are mutually co-ordinated so that each nail-accommodating hole will extend through said two parts, and wherewith each hole belonging to said first part has a cross-sectional size that exceeds the cross-sectional size of the hoof-penetrating portion of said nail, characterized in that each hole belonging to said horseshoe-shaped first part has at its periphery distal from the horse's hoof a plurality of hole-encircling surface sections which are pair-wise coordinated and adapted for sliding co-action with nail-associated support surfaces proximal to the horse's hoof.

2. (Original) A horseshoe arrangement according to claim 1, characterized in that said second part is affixed to said first part through the medium of a moulding or casting process.

3. (Previously Amended) A horseshoe arrangement according to claim 1, characterized in that each hole in said first part has a square cross-sectional shape or an at least generally square cross-sectional shape, with two surface sections that face away from said hole forming two of said hole-encircling surface sections.

4. (Original) A horseshoe arrangement according to claim 3, characterized in that each hole in said first part has further surface sections that face away from the hole forming a further two of said hole-encircling surface sections.

5. (Previously Amended) A horseshoe arrangement according to claim 3, characterized in that the surface sections which face away from the hole function to permit relative movement between the hoof-penetrating portion of said nail and said hole up to a first chosen value.

6. (Original) A horseshoe arrangement according to claim 5, characterized in that two other surface sections that face away from the hole function to permit relative movement between the hoof-penetrating portion of said nail and said hole up to a second chosen value.

7. (Original) A horseshoe arrangement according to claim 5, characterized in that said relative movement is directed transversely to a longitudinal extension of the first part.

8. (Original) A horseshoe arrangement according to claim 1, characterized in that the hoof-proximal nail-associated support surfaces have an extension which is adapted for co-action with surface sections that face away from the hole when a nail has been inserted to a hole-end position.

9. (Original) A horseshoe arrangement according to claim 1, characterized in that the distance of the hole between mutually opposing delimiting surfaces coincides with, or at least essentially with, twice the thickness of the hoof-penetrating portion of said nail.

10. (Original) A horseshoe arrangement according to claim 1, characterized in that said surface sections are orientated at right angles to a centre axis of the hole.

11. (Original) A horseshoe arrangement according to claim 1, characterized in that said surface sections are orientated within a centre part of said first horseshoe part; and in that said first horseshoe part has surface portions that are divergent towards the second horseshoe part.

12. (Previously Amended) A horseshoe arrangement according to claim 1, characterized in that said second part has a ground-proximal hole that includes convergent surfaces.

13. (Original) A horseshoe arrangement according to claim 12, characterized in that the head portion of said nail is adapted to lie tightly against said convergent surfaces.

14. (Previously Amended) A horseshoe arrangement according to claim 1, characterized in that said divergent surface portions and said convergent surfaces are mutually coordinated to form a hole cavity within which the nail can move freely, at least sideways.

15. (Currently Amended) A nail adapted for use in conjunction with a horseshoe arrangement according to claim 1, said nail having a head portion and a hoof-penetrating portion, characterized in that the nail includes a widened portion between said two portions.

16. (Original) A nail according to claim 15, characterized in that said widened portions include slide surfaces that face towards said hoof-penetrating portion.

17. (Previously Amended) A nail according to claim 15, characterized in that said widened portion includes slide surfaces that are orientated at right angles to a nail centre line.

18. (Original) A nail according to claim 15, characterized in that said widened portion has a length which is measurable along a centre line and which corresponds to, or is slightly shorter than, the corresponding length of the head portion.

19. (Previously Amended) A nail according to claim 15, characterized in that said widened portion has the shape of a truncated pyramid.

20. (Original) A nail according to claim 19, characterized in that the base surface of said pyramid consists of said slide surfaces.
